(19) United States
(12) Patent Application Publication
(10) Pub. No.: US 2011/0024569 A1
(43) Pub. Date: Feb. 3, 2011

(54) ATTENUATED LANDING SYSTEM

(75) Inventors: Tom Yandle, Palmetto, FL (US); Brian Ford, Seminole, FL (US)

Correspondence Address: Gray Robinson;ATTN: STEFAN V. STEIN/ IP DEPT., 201 N. Franklin Street, Suite 2200, Post Office Box 3324, TAMPA, FL, 33601-3324, US

(73) Assignee: Conax Florida Corporation, St. Petersburg, FL (US)

(21) Appl. No.: 12/788,063

(22) Filed: May 26, 2010

Related U.S. Application Data
(60) Provisional application No. 61/181,446, filed on May 27, 2009.

(51) Int. Cl. B64D 17/78

(52) U.S. Cl. 244/142

(57) ABSTRACT

Disclosed is an attenuated landing system. The landing system includes one or more inflatable structures that are mounted to the underside of a cargo platform. A terrain sensor is likewise mounted to the underside of the cargo platform and is activated upon being air-dropped. Once terrain is detected, pressurized gas vessels are pyrotechnically activated to inflate the structures. Once fully inflated, the structures effectively cushion the landing of the cargo platform and, thereby, protect sensitive on-board equipment.

### CROSS-REFERENCE TO RELATED APPLICATIONS

This application claims priority to co-pending Provisional Application Ser. No. 61/181,446 filed on May 27, 2009 and entitled “Attenuated Landing System.” The contents of this co-pending application are fully incorporated herein.

### BACKGROUND OF THE INVENTION

1. Field of the Invention

This invention relates to an attenuated landing system. More particularly, the present invention relates to a cushioning system for an air-dropped cargo platform.

2. Description of the Background Art

The use of air-dropped cargo platforms is known in the art. These platforms typically include a rigging that deploys a parachute shortly after the platform exits an aircraft. The parachute ensures that the cargo platform slowly travels to the ground below. Even with a parachute, however, such air-dropped cargo platforms land with considerable force, which often damages the associated cargo. This is especially true when the cargo platform is carrying sensitive equipment and/or electronics. Thus, there exists a need in the art for a cushioning system that absorbs the landing forces encountered by air-dropped cargo. There further exists a need in the art for a cushioning system that is deployed by a terrain sensor. The present invention is aimed at fulfilling these needs.

### SUMMARY OF THE INVENTION

It is therefore one of the objectives of this invention to more effectively cushion the landing of air-dropped cargo.

It is another object of this invention to deploy a cushioning system prior to contact with the ground.

It is another object of this invention to monitor the terrain below a cargo platform such that the cushioning system is deployed shortly before impact.

Still yet another object of this invention is to prevent air dropped palletized cargo from tipping over after landing.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a perspective view of the top of the landing system of the present invention.

FIG. 2 is a perspective view of the bottom of the landing system of the present invention.

FIG. 3 is a view of the cargo platform and associated landing system being dropped from an aircraft.

FIG. 4 is a side elevational view of the cargo platform and landing system with a deployed parachute.

FIG. 5 is a perspective view of the bottom of the landing system with the terrain sensor being extended.

FIG. 6 is a side elevational view of the landing system with the terrain sensor fully extended.

FIG. 7 is a side elevational view of the landing system wherein the terrain sensor has been activated and the cushioning system is being inflated.

FIG. 8 is a side elevational view of the cushioning system upon contact with the ground and with the side inflatable structures being deployed.

FIG. 9 is a side elevational view of the cushioning system being deflated after contact with the ground and with the side inflatable structure fully deployed.

FIG. 10 is a side elevational view of an additional embodiment of the present invention.

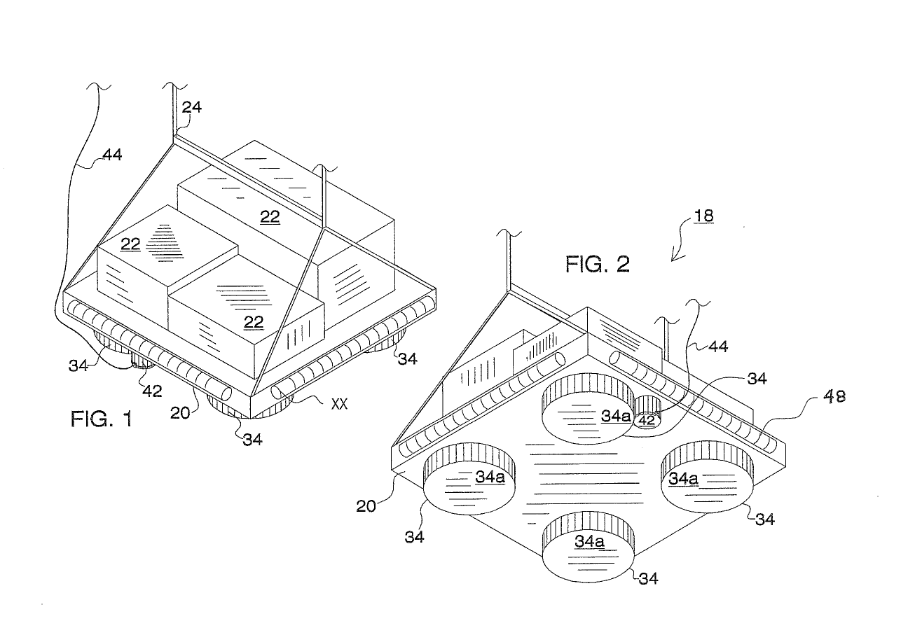

Similar reference characters refer to similar parts throughout the several views of the drawings.

PARTS LIST

| | |
|---|---|
| 18 | System |
| 20 | Cargo Platform |
| 22 | Containers |
| 24 | Harness |
| 26 | Parachute |
| 28 | Rip Cord |
| 32 | Aircraft |
| 34 | Cylindrical Container |
| 34a | Container Face |
| 36 | Inflatable Structures |
| 38 | Terrain Sensor |
| 38a | Impact Sensor |
| 38b | Tether |
| 42 | Package Assembly |
| 44 | Lanyard |
| 46 | Terrain |
| 48 | Side Containers |
| 52 | Inflatable Side Structure |
| 54 | Protective Cover |

### DETAILED DESCRIPTION OF THE PREFERRED EMBODIMENT

The present invention relates to an attenuated landing system. More specifically, the invention relates to a landing system that includes one or more inflatable structures that are mounted to the underside of a cargo platform. A terrain sensor is also mounted to the cargo platform and is activated after being dropped from an aircraft. Once terrain is detected, the inflatable structures are activated and inflated to cushion the landing of the cargo platform and, thereby, protect sensitive equipment from being damaged. Inflatable side structures are optionally mounted about the periphery of the cargo platform and are activated in the event the platform becomes unstable after landing. The various details of the present invention, and the manner in which they interrelate, are described in greater detail hereinafter.

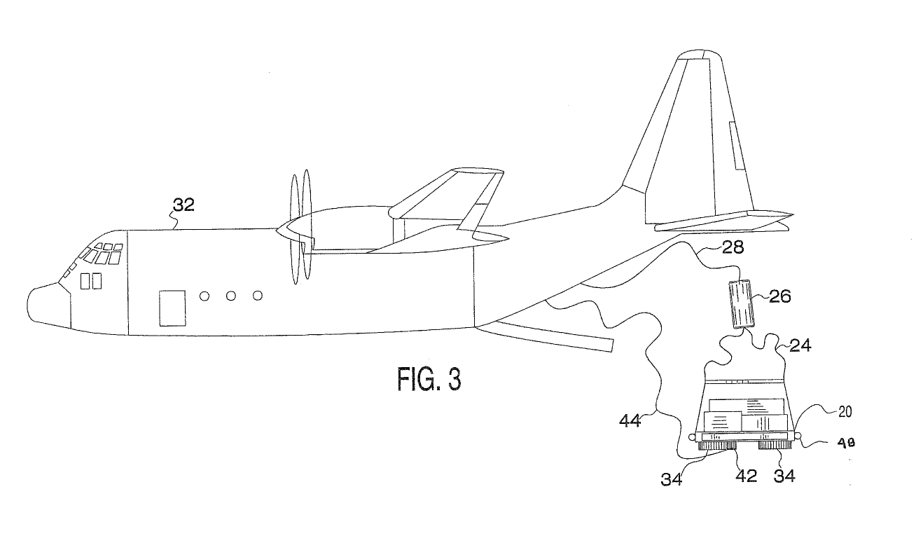

With reference now to FIG. 2, the inflatable system 18 of the present invention is depicted. System 18 includes a cargo platform 20 that is designed to carry one or more containers 22, which may store, for example, food, water, munitions, electronic equipment, and/or survival gear. As is known in the art, each corner of the platform 20 may be coupled to a harness or rigging 24 that, in turn, is coupled to one or more parachutes. In the depicted embodiment, a single parachute 26 is included and is deployed via rip cord 28 upon platform 20 exiting an aircraft 32 (note FIG. 3). Parachute 26 keeps platform 20 level and greatly slows its decent. However, even with a parachute assisted decent, a cushioning system 18 is needed to lessen the impact upon landing.

FIG. 2 illustrates the landing system 18 of the present invention in its un-deployed and un-activated state. As illustrated, the preferred system includes four cylindrical containers 34 that are mounted to the underside of platform 20 at the four corners. As described more fully hereinafter, each of the containers 34 houses an inflatable structure 36 that expands (and breaks container face 34a) prior to impact. The shape and configuration of the inflatable structures 36, as well as the associated containers 34, can be varied depending upon the nature of the load being carried and the size and shape of platform 20. For instance, rectangular structures can be used in lieu of cylindrical structures. Additionally, the number and spacing of the structures, and associated containers, can be varied as needed depending upon the weight of cargo.

In the preferred embodiment, each container 34 houses a pressurized gas vessel that serves to inflate the associated structure 36 with a compressed gas, such as air. In the preferred embodiment, the gas vessels are activated pyrotechnically. Pyrotechnic gas generators can optionally be employed in lieu of gas vessels. As is known in the art, pyrotechnic gas generators covert solid material into a pressurized gas. In yet another embodiment, structures 36 are filled with an expansible foam instead of a gas. Structures 36 can be filled with still yet other fluids and/or gases that provide a sufficient degree of energy absorption upon impact.

Furthermore, although it is preferred to inflate structures 36 with a gas or fluid, still yet other cushioning means are within the scope of the present invention. For example, structures 36 could employ internally mounted springs that are activated via a one way valve prior to impact. Another option is to build structures 36 from a cardboard material that is gravity deployed and that crushes upon impact. Again, whatever cushioning means is employed, it must absorb a sufficient amount of energy upon impact to protect the associated cargo 22.

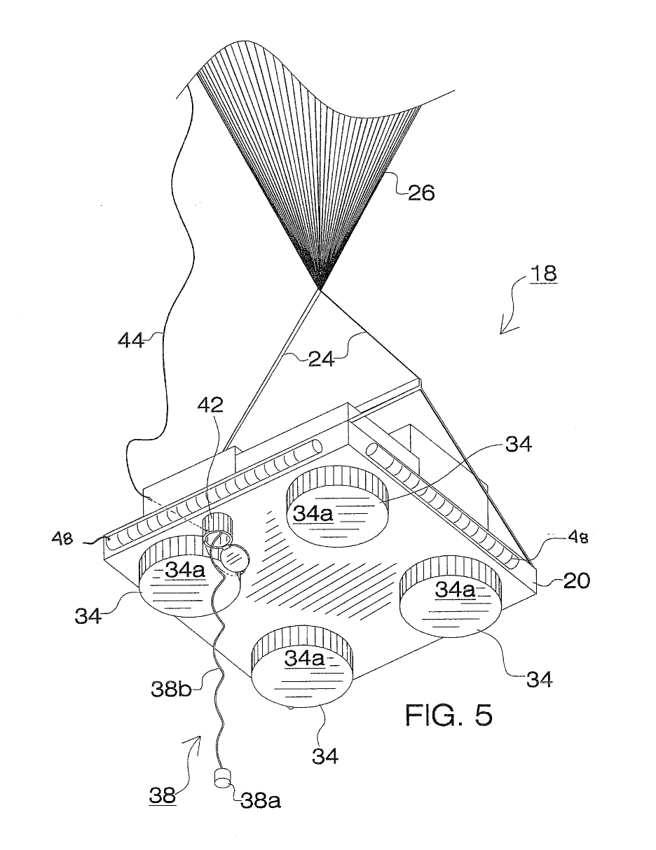

With reference to FIGS. 2 and 5, the terrain sensor 38 is next described. In the un-deployed state, terrain sensor 38 is housed within an electronic package assembly 42 that is likewise mounted on the underside of cargo platform 20. Although a variety of mounting positions are possible, in the depicted embodiment, package assembly 42 is mounted adjacent one of the side edges of platform 20. Once the cargo platform 20 leaves aircraft 32, a lanyard 44 serves to open electronic package 42 and deploy terrain sensor 38. FIG. 5 illustrates terrain sensor 38 being extended after lanyard 44 has been pulled. As illustrated, terrain sensor 38 comprises an impact sensor 38a that is positioned at the end of a tether 38b. In the depicted embodiment, a single terrain sensor 38 operates all four inflatable structures 36. However, it is within the scope of the present invention to utilize a separate sensor 38 for each inflatable structure 36. Although a tethered sensor 38 is disclosed, the use of other sensors is within the scope of the present invention. For example, tether 38b can be eliminated by utilizing a radar based terrain sensor.

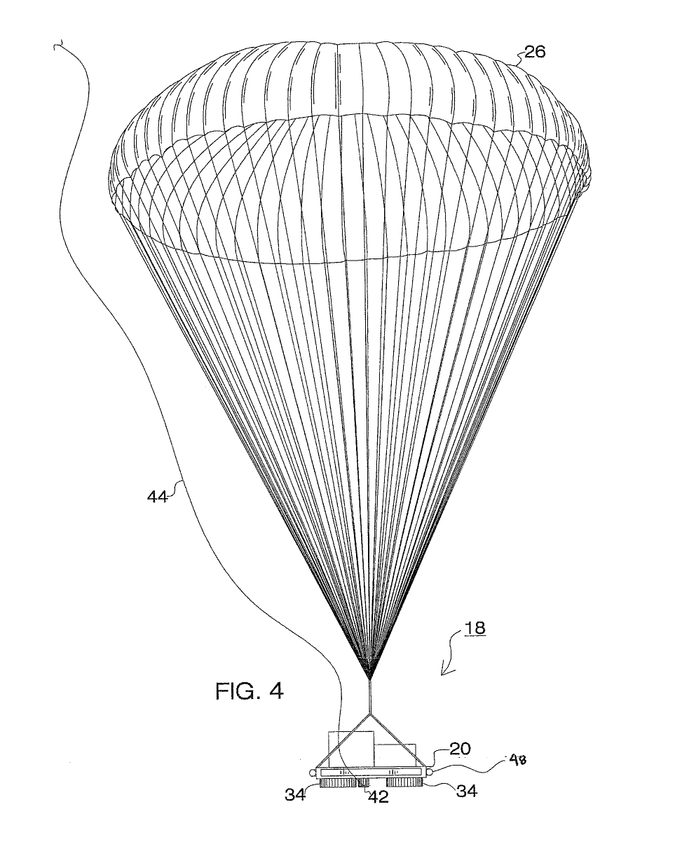

In use, cargo platform 20 is air dropped from an aircraft 32 in flight. In the embodiment depicted in FIG. 3, platform 20 is exiting the back of a Lockheed C-130. As platform 20 leaves aircraft 32, rip cord 28 is pulled to deploy the associated parachute 26. FIG. 3 illustrates the platform rigging 24 associated with parachute 26. FIG. 4 illustrate platform 20 with a fully deployed parachute 26. As noted, a lanyard 44 is also included for activating terrain sensor 38. Namely, as platform 20 exits aircraft 32, lanyard 44 pulls a pin upon assembly 42, which, in turn, opens the assembly 42 to allow terrain sensor 38 to extend downwardly from the underside of platform 20. The opening of assembly 42 further arms the inflatable system 18.

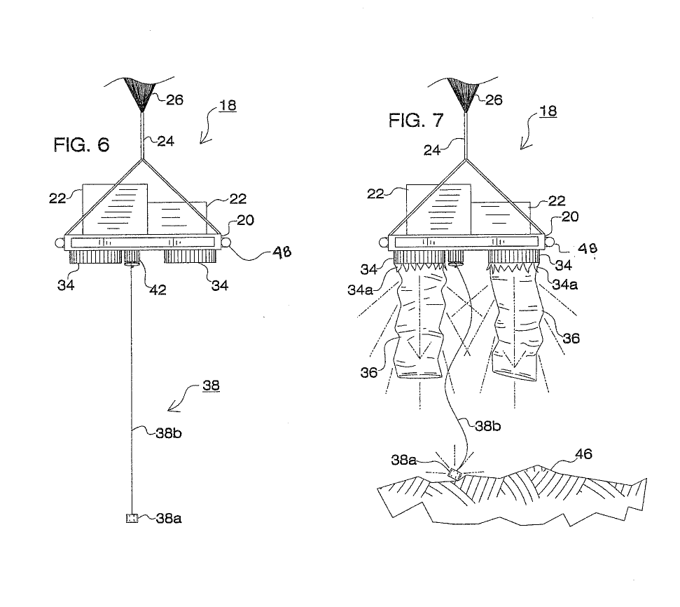

Once fully extended (note FIG. 6), sensor 38 awaits contact with the terrain 46 below. Once contact is made, sensor 38 sends a signal to each of the four pressurized gas vessels positioned within containers 34. This signal, in turn, causes each of the gas vessels to be pyrotechnically activated. The activation signal may be provided via wiring between sensor 38 and containers 34. Alternatively, the activation signal can be provided wirelessly from sensor 38. As a result of the activation signal, inflatable structures 36 are immediately inflated with a gas, such as pressurized air or nitrogen. Each container 34 has a lower face 34a formed from a frangible membrane that is broken upon inflation of the structure 36 housed therein (note FIG. 7). In the depicted embodiment, inflatable structures 36 are cylindrically shaped.

Impact sensor 38a and its associated tether 38b are preferably longer than the length of the fully inflated structures 36. This differential gives the inflatable structures 36 sufficient time to fully inflate before contacting terrain 46. The length of the differential will depend, in part, upon the deployment time of inflatable structures 36. Tether 38b should also be sufficiently long enough to accommodate a wide range of payload weights, and vertical and horizontal velocities associated with the descent of the payload. Namely, heavier payloads, or payloads with smaller parachutes, may have increased decent velocities that require longer tether lengths. In an alternative embodiment, the length of tether 38(b) dispensed from assembly 42 can be varied. Additionally, an on-board microprocessor (not shown) is included for computing the proper length of tether 38(b) on the basis of payload weight and decent velocity. The microprocessor can also be used to determine payload weight and detect decent velocity. Decent velocity can be detected after deployment of parachute 26. These values can then be used by microprocessor to compute a tether length 38(b) that ensures that structures 36 have sufficient space to fully inflate.

Upon contact with the ground 46, inflatable structures 36 serve to eliminate any jarring forces to the associated cargo 22. After contact, the air within the inflatable structures 36 is vented to the atmosphere via one or more vents (not shown). Thus, immediately after impact, inflatable structures 36 begin to slowly deflate to bring the platform 20 to ground level. The inflatable structures 36 preferably deflate at a uniform rate such that platform 20 is kept level during deflation. Furthermore, a level sensor, such as a gyroscope or accelerator, can be positioned upon platform 20 to determine whether platform 20 is level. In the event the sensor determines a non-level condition, on-board controllers can regulate the deflation of structures 36 to compensate. Namely, the deflation of one or more of the structures 36 can be delayed (or prevented altogether) while the remaining structures 36 are deflated as normal. This selective deflation would ensure that even in mountainous terrain platform 20 and the associated cargo 22 remain level upon landing. In this manner, inflatable structures 36 serve to effectively attenuate the landing of platform 20. Finally, those skilled in the art will appreciate that system 18 can be retrofitted to existing cargo platforms 20.

System 18 can optionally include one or more side mounted containers 48 that house side inflation members 52 about the periphery of platform 20. In the depicted embodiment, platform 20 includes four containers 48 mounted to each of the four sides of platform 20. However, it is within the scope of the present invention to utilize side containers 48 on fewer than all four sides. Containers 48 may be mounted in still yet other configurations depending upon the size and shape of platform 20. Side containers 48 are preferably frangible and house side inflatable structures 52. The function and operation of side structures 52 is the same as the inflatable structures 36 described hereinabove. Both structures 36 and 52 are preferably cylindrical shape after being fully deployed. However, the longitudinal axis of structures 36 is preferably perpendicular to platform 36 and the longitudinal axis of structures 52 is preferably parallel to the sides of platform 20.

The side inflatable structures 52 are selectively deployed to prevent the platform 20 and associated containers 22 from becoming unbalanced after impact. More specifically, if structures 36 land upon rocky or uneven terrain, structures 52 can be deployed to prevent platform from rolling over or falling to one side. This, in turn, further prevents damage to the payload. Structures can be selectively deployed by a platform orientation sensor (or sensors) to maintain platform 20 in a level orientation. Platform orientation sensor can optionally be the above described sensor employed in regulating the deflation of structures 36.

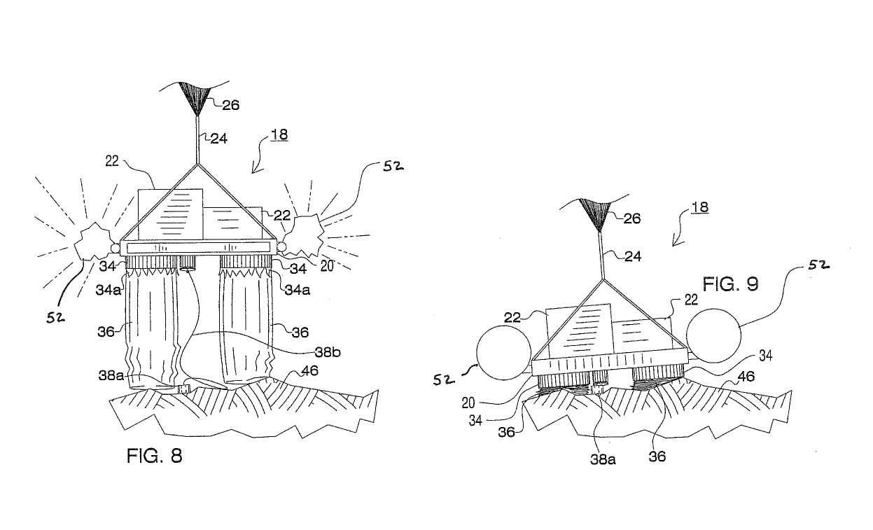

FIGS. 8 and 9 show the side structure 52 being deployed from container 48 in the event of an imbalanced landing. The platform orientation sensor used to deploy structures 52 can take the form of an accelerometer or a gyroscope, either of which can detect the inclination of platform 20. Side inflatable structure 52 are deployed along one or more edges in the event the sensor detects platform 20 pitching beyond a predetermined amount. As noted above, structures 52 can be deployed either by a pyrotechnically activated gas vessel or via an associated pyrotechnic gas generator. In one non-limiting example, sensor may deploy structure 52 along any edge that inclines downward more than 15% from horizontal.

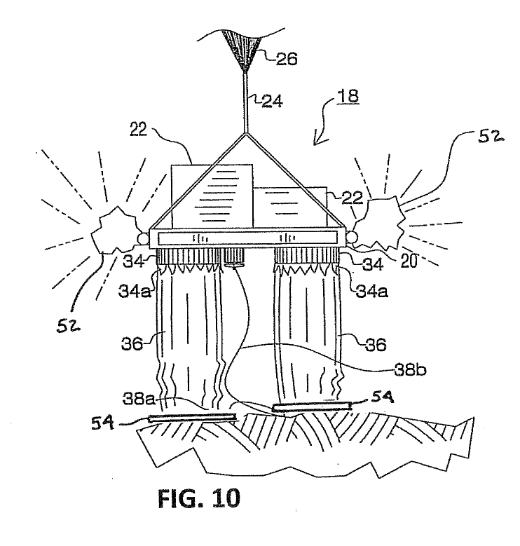

FIG. 10 illustrates another alternative embodiment of the present invention. In this embodiment, a protective rigid surface 54 is secured to the bottom of each inflatable structure 36. Surfaces 54 can be made from, for example, steel or aluminum. Similar surfaces can optionally be secured to the top and/or side surfaces of structures 36. Surfaces 54 function in preventing inflatable structures 36 from being punctured or otherwise becoming damaged upon landing. Inflatable side structures 52 can likewise utilize protective surfaces 54.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A system for cushioning the landing impact of palletized cargo, the system comprising:
a platform having upper and lower surfaces and a peripheral edge therebetween, a harness secured to the upper surface and a parachute connected to the harness, equipment mounted to the upper surface of the platform, a rip cord coupled to the parachute for use in deploying the parachute;
a series of four containers mounted to the lower surface of the platform, each of the four containers including a frangible lower face, an inflatable structure positioned within each of the four containers, each of the structures being inflatable to a full length via an associated pyrotechnic gas generator that is initiated by way of an activation signal, wherein the frangible lower faces of containers are ruptured upon inflation of structures;
a package assembly mounted to the lower surface of the platform adjacent the peripheral edge, the package assembly housing a tether having an impact sensor at its distal end, a lanyard secured to the package assembly and adapted to open the package assembly and permit deployment of the tether and impact sensor, the tether being longer than the inflatable structures in the deployed state, the impact sensor sending an activation signal to deploy inflatable structures such that the inflatable structures are fully deployed prior to contacting the ground, whereby the palletized cargo is protected from the impact associated with landing;
one or more side containers mounted to the peripheral edge of the platform, the side containers housing inflatable side structures, a platform orientation sensor for selectively deploying one or more of the side inflatable structures upon platform taking an inclined orientation, the side inflatable structures thereby preventing the platform from tipping after landing.

2. A system for cushioning the landing impact of palletized cargo, the system comprising:
a platform having upper and lower surfaces and a peripheral edge therebetween, equipment mounted to the upper surface of the platform;
a container mounted to the lower surface of the platform, an inflatable structure positioned within the container;
an impact sensor associated with the platform, the impact sensor sensing terrain and deploying the inflatable structure prior to impact, the impact sensor being calibrated such that the inflatable structure is fully inflated just prior to the inflatable structure contacting the sensed terrain.

3. The system as described in claim 2 wherein the impact sensor is tethered and a lanyard is secured to the package assembly and opens the package assembly once the platform is airborne, the tethered impact sensor sending an activation signal to deploy the structure such that structure is fully deployed prior to contacting the ground.

4. The system as described in claim 2 wherein one or more side containers are mounted to the peripheral edge of the platform, the side containers housing inflatable side structures, a platform orientation sensor for selectively deploying one or more of the side inflatable structures upon platform taking an inclined orientation, the side inflatable structures thereby preventing the platform from tipping after landing.

5. The system as described in claim 2 wherein the structure is inflated by a pyrotechnic gas generator.

6. The system as described in claim 2 wherein compressed air is used to inflate the structure.

7. The system as described in claim 2 wherein a dense foam is used to inflate the structure.

8. The system as described in claim 2 wherein the platform is secured to a parachute via a rigging.

9. The system as described in claim 2 wherein valves are included for deflating the structure after impact and deflation control means are provided for ensuring that platform remains level during deflation.

10. A system for cushioning the landing impact of airborne cargo, the system comprising:
a platform having upper and lower surfaces and a peripheral edge therebetween;
a first container associated with the platform, a first inflatable structure positioned within the first container;
an impact sensor associated with the platform, the impact sensor sensing terrain and deploying the first inflatable structure prior to impact;
a second container associated with the platform, a second inflatable structure positioned within the second container;
a platform orientation sensor, the platform orientation sensor inflating the second inflatable structure upon detecting an unlevel orientation of the platform.

11. The system as described in claim 10 wherein the first inflatable structure is an airbag and wherein the first container ruptures upon inflation of the first inflatable structure.

12. The system as described in claim 10 wherein the second inflatable structure is an airbag and wherein the second container ruptures upon inflation of the second inflatable structure.

13. The system as described in claim 10 wherein the first inflatable structure is pyrotechnically inflated.

14. The system as described in claim 10 wherein the second inflatable structure is pyrotechnically inflated.

15. The system as described in claim 10 wherein the impact sensor is tethered to the platform.

16. The system as described in claim 10 wherein a protective surface is secured to the first inflatable structure to prevent it from being punctured.

17. The system as described in claim 10 wherein a protective surface is secured to the second inflatable structure to prevent it from being punctured.
